(19) United States
(12) Patent Application Publication
(10) Pub. No.: US 2009/0214226 A1
(43) Pub. Date: Aug. 27, 2009

(54) OPTICAL DQPSK RECEIVER AND OPTICAL PHASE MONITOR APPARATUS FOR USE IN OPTICAL DQPSK RECEIVER

(75) Inventors: Noriaki MIZUGUCHI, Kawasaki (JP); Yoshikazu Terayama, Kawasaki (JP); Kenichi Kaburagi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/241,962

(22) Filed: Sep. 30, 2008

(30) Foreign Application Priority Data
Feb. 22, 2008 (JP) 2008-041442

(51) Int. Cl. H04B 10/06

(52) U.S. Cl. 398/202

(57) ABSTRACT

First and second delay interferometers respectively have a phase-shift element. First and second photo detectors respectively detect optical signals output from the first and second delay interferometers. First and second data recovery circuits recover data from signals detected by the first and second photo detectors, respectively. A common adjustment unit adjusts the phase-shift elements of both first and second delay interferometers in accordance with an output signal from the first photo detector and an output signal from the second data recovery circuit. An individual adjustment unit adjusts the phase-shift element of the second delay interferometer in accordance with the output signal from the first photo detector and an output signal from the second photo detector.

### BACKGROUND OF THE INVENTION

1. Field of the Invention

The present invention relates to an optical DQPSK (Differential Quadrature Phase Shift Keying) receiver for demodulating an optical DQPSK signal, and an optical phase monitor apparatus for use in an optical DQPSK receiver.

2. Description of the Related Art

While the capacity of optical communication systems has rapidly increased over the last decade, the modulation technique employed in the majority of realizations has remained binary amplitude shift keying (also referred as On-Off Key (00K)) in either NonReturn-to-Zero (NRZ) or Return-to-Zero (RZ) format.

Alternative modulation and demodulation techniques have been employed recently in optical communications, such as duobinary, Carrier-Suppressed Return-to-Zero (CSRZ) and Differential Phase Shift Keying (DPSK).

In DPSK format, the information is carried by phase change between two adjacent symbols. The phase change is limited to “0” and “π” in binary DPSK. The method using four phase changes (0, π/2 , π, 3π/2) is called DQPSK. Compared with traditional OOK, DPSK improves optical signal-to-noise ratio (OSNR) by about 3 dB and also enhances robustness to nonlinear effects.

Because the optical DQPSK transmits the four-level symbol, it doubles the spectral efficiency, which alleviates the requirements of electrical device speed, optical dispersion adjustment, polarization mode dispersion, and soon. In summary, optical DQPSK is a promising candidate for the next generation optical communication system.

A typical optical DQPSK receiver consists of a pair of Mach-Zehnder interferometers, corresponding to I branch and Q branch respectively, each with an optical delay τ equal to the symbol period of the transmission system. The optical phase difference between branches in one (for example, the I branch) of the interferometers is set to π/4 and the optical phase difference between branches in the other (for example, the Q branch) is set to −π/4. A pair of output terminals of the interferometers are connected to balanced photo detectors to recover the transmitted data. The configuration and operation of an optical DQPSK transmitter and an optical DQPSK receiver are also described in, for example, in Patent Document 1 (Japanese Patent Application Publication (Translation of PCT Application) No. 2004-516743 (WO2002/051041, US2004/008147)).

FIG. 1 shows an example of the configuration of an optical DQPSK transmission system. An optical transmitter 200 shown in FIG. 1 includes a DQPSK precoder 210, a light source 220, phase modulators 230A and 230B, and an intensity modulator 240. The DQPSK precoder 210 generates a pair of data (data 1 and data 2) from transmission data. The light source 220 generates CW light having a predetermined wavelength. The CW light is input to the phase modulators 230A and 230B. The pair of CW light input to the phase modulators 230A and 230B is controlled so that the phase shift between each of the pair becomes π/2.

The phase modulator 230A modulates the optical phase of the CW light generated by the light source 220 to “0” or “π”, in accordance with the data 1. The phase modulator 230B modulates the optical phase of the CW light to “π/2” or “3π/2”, in accordance with the data 2. The output signals from the phase modulators 230A and 230B are combined to obtain an optical DQPSK signal. The intensity modulator 240 performs RZ intensity modulation for the optical DQPSK signal, which is then transmitted to an optical transmission path 401. The optical transmission path 401 is a WDM (Wavelength Division Multiplexing) line.

In this example, the optical transmission path 401 is provided with an optical WDM circuit 402, an optical amplifier (AMP), and a demultiplexing circuit 403 for demultiplexing the WDM light with respect to wavelength. In addition, in this example, a remaining dispersion compensator 404 is provided in a preceding stage of an optical receiver 300. In general, the optical S/N ratio deteriorates in the optical amplifier, and wavelength dispersion occurs with long-haul optical fiber transmission.

The optical receiver 300 includes delay interferometers 310A and 310B, balanced photo detectors (TWIN-PD) 320A and 320B, decision circuits 330A and 330B, a decoder 340, and a control circuit 350. The optical DQPSK signal is split and provided to the delay interferometers 310A and 310B.

The delay interferometer 310A outputs a combined signal of a signal corresponding to the optical DQPSK signal with a 1-symbol-time delay and a signal corresponding to the optical DQPSK signal with π/4 shift. Meanwhile, the delay interferometer 310B outputs a combined signal of a signal corresponding to the optical DQPSK signal with a 1-symbol-time delay and a signal corresponding to the optical DQPSK signal with a π/4 shift. The balanced photo detectors 320A and 320B respectively convert the optical signals output from the delay interferometers 310A and 310B into electric signals.

The decision circuits 330A and 330B respectively recover data (an I-channel signal and a Q-channel signal) from the signals obtained in the photo detectors 320A and 320B. The decoder 340 performs, for the I-channel signal and the Q-channel signal, a bit-replacement process that corresponds to the process performed by the DQPSK precoder 210, thereby recovering the transmission data.

In an optical receiver 300 having the above configuration, a very important issue is that the optical phase difference between the arms of the delay interferometer 310A is adjusted exactly to π/4 and the optical phase difference between the arms of the delay interferometer 310B is adjusted exactly to −π/4. An inaccurate adjustment of the optical phase difference causes the deterioration of the optical S/N ratio. For this reason, the optical receiver 310 is provided with the control circuit 350. The control circuit 350 adjusts the optical phase difference for the delay interferometers 310A and 310B by feedback control. Specifically, the control circuit 350 monitors the phase error of the delay interferometers 310A and 310B, and generates phase adjustment signals to keep the optical phase difference at a target value.

One typical feedback control method is the dither-peak-detection method. In this method, the phase of an optical signal in the delay interferometer is slightly dithered with a fixed frequency f, while monitoring the 2f component contained in the output signal of the delay interferometer. When the phase difference in the delay interferometer is kept at the target value, the 2f component becomes minimum (or, local minimum). In other words, when the feedback control is performed so as to make the 2f component minimum (or, local minimum), the phase difference in each delay interferometer can be adjusted to the respective target value.

However, the dither-peak-detection method has following problems.
1. The phase dithering with the frequency f causes the deterioration of the S/N ratio.
2. The detection of the local minimum value only indicates whether the actual phase is kept at the target value. It cannot indicate whether the actual phase is larger or smaller than the target value.
3. The signal indicating the amount the 2f component is usually quadric to the phase error. Therefore, the adjustment sensitivity decreases when the phase error is close to zero.
4. The phase control speed is limited by the dither frequency (the frequency f mentioned above).

Patent Document 2 (Japanese Patent Application Publication No. 2007-20138) has been known as describing a configuration for solving the above problems.

FIG. 2 shows the configuration of an optical DQPSK receiver described in Patent Document 2. In the description regarding FIG. 2, one of the I branch and Q branch is called A branch, and the other of the I branch and Q branch is called B branch.

In FIG. 2, the input optical DQPSK signal (or RZ-DQPSK signal) is directed to a delay interferometer 104 provided in the A branch and a delay interferometer 107 provided in the B branch. The delay interferometers 104 and 107 correspond to the delay interferometers 310A and 310B shown in FIG. 1, respectively. Accordingly, the delay interferometers 104 and 107 respectively include an optical-delay element and a phase-shift element. The phase of the phase-shift element (the phase difference between the arms of the delay interferometer) is adjusted utilizing temperature change, in the example shown in FIG. 2. For example, an increase in the temperature of the phase-shift element makes the phase larger.

A photo detector (Twin-PD) 110 corresponds to the balanced photo detector 320A shown in FIG. 1, and generates a current signal corresponding to the output light from the delay interferometer 104. The photo detector 110 also includes a trans impedance amplifier (TIA) to convert and output the generated current signal into a voltage signal.

A decision circuit 111 corresponds to the decision circuit 330A shown in FIG. 1 and generates a data signal 125 from a signal 124 output from the photo detector 110. The data signal 125 corresponds to the I-branch signal input to the decoder 340 in FIG. 1. In the same manner, in the B branch, a photo detector 113 outputs a signal 128, and a decision circuit 114 outputs a data signal 129.

The signal 124 output from the photo detector 110 in the A branch and the data signal 129 output from the decision circuit 114 in the B branch are input to a mixer 116. Meanwhile, a Bessel low pass filter may be provided between the transimpedance amplifier of the photo detector 110 and the mixer 116, and between the decision circuit 114 and the mixer 116. In this case, when the bit rate of the output signal is 21.5 Gbps, the cutoff frequency is, for example, about 100 MHz.

The mixer 116 multiplies the signals 124 and 129. In other words, the mixer 116 multiplies the linear amplified signal 124 tapped from the input side of the decision circuit 111 in the A branch and the data signal 129 tapped from the output side of the decision circuit 114 in the B branch. In the same manner, a mixer 120 multiplies the linear amplified signal 128 tapped from the input side of the decision circuit 114 in the B branch and the data signal 125 tapped from the output side of the decision circuit 111 in the A branch.

The signal 126 output from the mixer 116 is averaged by an averaging circuit 117. The averaging circuit 117 is, for example, a low pass filter. A phase adjustment unit 119 performs a calculation for an averaged signal 127, to generate a phase modulation signal for the A branch.

The phase modulation signal obtained by the phase adjustment unit 119 is provided to a phase-shift element 106 in the A branch. The phase of the phase-shift element 106 changes, for example, depending on the temperature. In this case, the phase modulation signal plays the role of adjusting the temperature of the phase-shift element 106. Then, a microcontroller 112 adjusts the phase-shift element 106 so that the signal 127 becomes zero, there by adjusting the phase of the phase-shift element 106 to the target value (π/4).

In the same manner, in B branch, the phase modulation signal obtained by the phase modulation unit 123 is provided to the phase-shift element 109. A microcontroller 115 then adjusts the phase-shift element 109 so that the signal 133 becomes zero, thereby adjusting the phase of the phase-shift element 109 to the target value (−π/4).

The polarity of the signal 127 (or 133) is determined in accordance with the direction of the shift of the phase of the phase-shift element 106 (or 109) with respect to the target value. For example, in a configuration in which the value of the signal 127 becomes positive when the phase of the phase-shift element 106 is shifted to the positive direction with respect to the target value, the value of the signal 127 becomes negative when the phase of the phase-shift element 106 is shifted to the negative direction. Therefore, whether the phase of the phase-shift element 106 (or 109) is shifted to the positive direction or the negative direction can be determined, in accordance with the polarity of the signal 127 (or 133).

Thus, the configuration described in Patent Document 2 makes it possible to detect not only the amount of the phase error of the phase-shift element in each delay interferometer but also the direction of the phase error. In addition, a phase variation as in the dither-peak-detection method is not to be given in this configuration. Therefore, the deterioration of the optical S/N ratio can be suppressed in the configuration, and the time required for the adjustment of the phase-shift elements can be shortened. However, the configuration requires a large circuit scale.

### SUMMARY OF THE INVENTION

An object of the embodiment is to reduce the circuit size of an optical DQPSK receiver.

A disclosed optical DQPSK receiver includes: a first branch circuit including a first delay interferometer having a first phase-shift element, a first photo detector for detecting output light from the first delay interferometer, and a first recovery circuit for recovering data from an output signal from the first photo detector; a second branch circuit including a second delay interferometer having a second phase-shift element, a second photo detector for detecting output light from the second delay interferometer, and a second recovery circuit for recovering data from an output signal from the second photo detector; a common adjustment unit for adjusting the first phase-shift element and the second phase-shift element; an individual adjustment unit for adjusting the second phase-shift element; and a control unit for controlling the common adjustment unit in accordance with a first signal output from the first photo detector and a second signal output from the second recovery circuit, and for controlling the individual control unit in accordance with the first signal and a third signal output from the second photo detector.

The control unit controls the common adjustment unit so that, for example, a phase of the first phase-shift element becomes π/4+nπ/2 (n is an integer). In this case, the control unit controls the individual adjustment unit so that a difference between the phase of the first phase-shift element and a phase of the second phase-shift element becomes π/2.

The optical DQPSK receiver may further include: a selector for selecting the first and second signals from the first through third signals when a first operation mode is specified by the control unit, and for selecting the first and third signals from the first through third signals when a second operation mode is specified by the control unit; a mixer for multiplying the two signals selected by the selector; and an averaging circuit for averaging an output signal from the mixer. In this case, the control unit controls, in the first operation mode, the common adjustment unit in accordance with an output signal from the averaging circuit, and controls, in the second operation mode, the individual adjustment unit in accordance with the output signal from the averaging circuit.

The optical DQPSK receiver may further include: a monitor circuit for monitoring an average optical input power in the first and second delay interferometers; and a division circuit for dividing the output signal from the averaging circuit by the average optical input power in the first delay interferometer when the first signal is selected by the selector, and for dividing the output signal from the averaging circuit by the average optical input power in the second delay interferometer when the third signal is selected by the selector.

The selector may select the second and third signals when a third operation mode is specified by the control unit. In this case, the control unit detects, in the third operation mode, an abnormal status by comparing an output signal from the averaging circuit with a predetermined threshold value.

Another disclosed optical DQPSK receiver includes a first branch circuit including a first delay interferometer having a first phase-shift element, a first photo detector for detecting output light from the first delay interferometer, and a first recovery circuit for recovering data from an output signal from the first photo detector; a second branch circuit including a second delay interferometer having a second phase-shift element, a second photo detector for detecting output light from the second delay interferometer, and a second recovery circuit for recovering data from an output signal from the second photo detector; a demultiplex circuit for demultiplexing data recovered by the first and second recovery circuits; a common adjustment unit for adjusting the first phase-shift element and the second phase-shift element; an individual adjustment unit for adjusting the second phase-shift element; and a control unit for controlling the common adjustment unit in accordance with a first signal output from the first photo detector and a second signal obtained by demultiplexing, in the demultiplex circuit, an output signal from the second recovery circuit, and for controlling the individual control unit in accordance with the first signal and a third signal output from the second photo detector.

### BRIEF DESCRIPTION OF THE DRAWINGS

FIG. 1 shows a configuration of an optical DQPSK system.

FIG. 2 shows the configuration of an optical DQPSK receiver described in Patent Document 2.

FIG. 3 shows the basic configuration of an optical DQPSK receiver according to an embodiment.

FIG. 4 shows an example of a photo detector.

FIG. 5 shows target conditions of phase-shift elements of a pair of delay interferometers.

FIGS. 6A-6C show adjustment methods of the phase-shift elements of the delay interferometers.

FIG. 7 shows a configuration of an optical DQPSK receiver according to the first embodiment.

FIG. 8 shows a flowchart representing the operations of a microcontroller in the first embodiment.

FIG. 9 shows a configuration of an optical DQPSK receiver according to the second embodiment.

FIG. 10 shows the operations of a DEMUX circuit.

FIG. 11 shows the operations of a mixer in the second embodiment.

FIG. 12 shows a variation example of the second embodiment.

### DESCRIPTION OF THE EMBODIMENTS

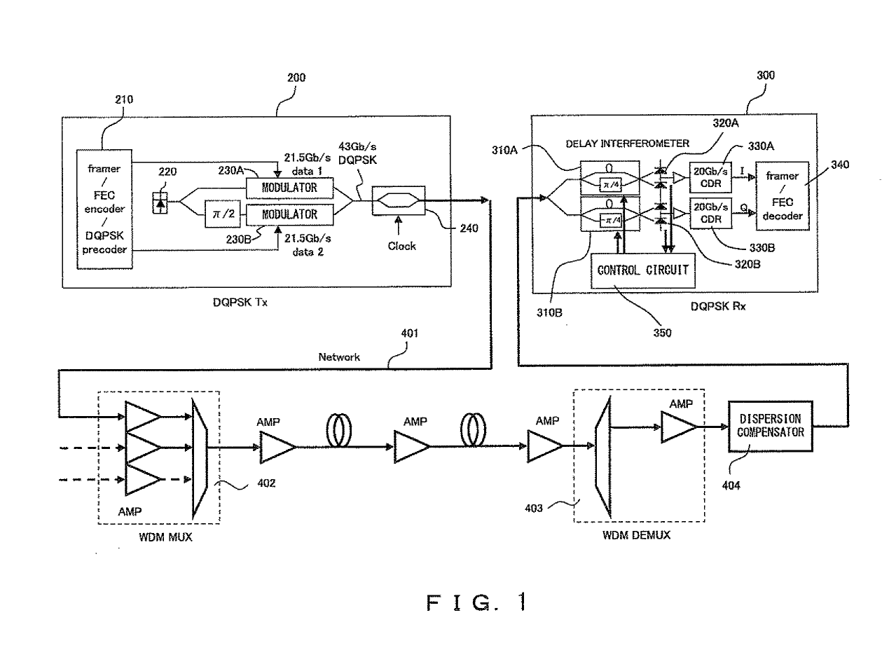

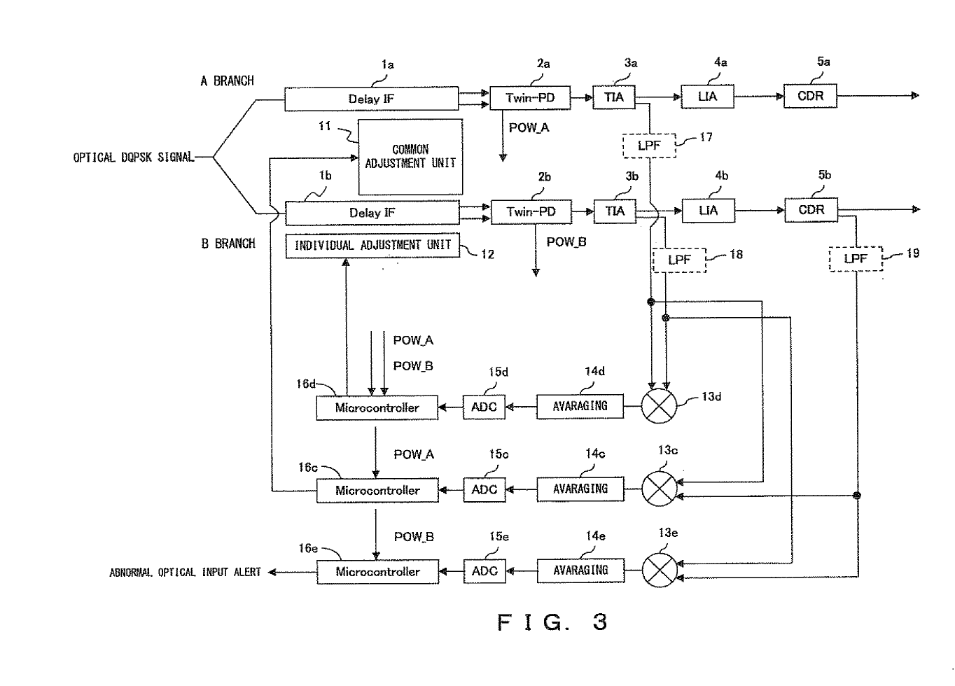

FIG. 3 shows the basic configuration of an optical DQPSK receiver according to an embodiment. The optical DQPSK receiver recovers transmitted data by demodulating an optical DQPSK signal. The data transmission rate ranges, while it is not limited particularly, for example, from several Gbps to several dozen Gbps. The optical DQPSK signal is generated by, for example, the optical transmitter 200 shown in FIG. 1.

The optical DQPSK signal is split by an optical splitter and directed to an A branch circuit and a B branch circuit. The A branch circuit is one of the I branch circuit and the Q branch circuit, and the B branch circuit is another of the I branch circuit and the Q-branch circuit. The A branch circuit includes a delay interferometer 1a, a photo detector (Twin-PD) 2a, a transimpedance amplifier (TIA) 3a, a limiter amplifier (LIA) 4a, and a data recovery circuit (CDR) 5a. In the same manner, the B branch circuit includes a delay interferometer 1b, a photo detector 2b, a transimpedance amplifier (TIA) 3b, a limiter amplifier 4b, and a data recovery circuit 5b.

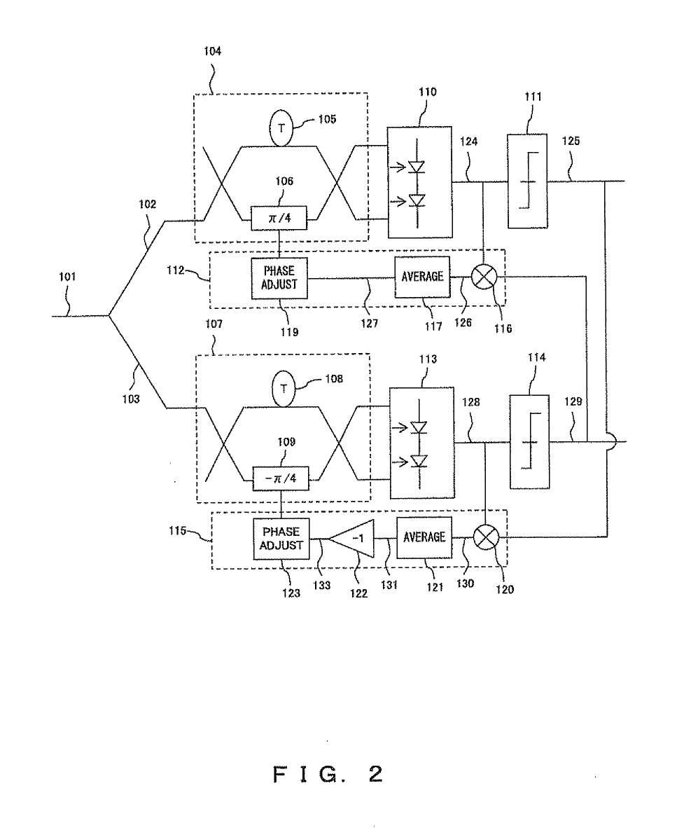

The delay interferometer 1a corresponds to the delay interferometer 104 shown in FIG. 2, and includes a splitting element, a delay element, a phase-shift element and a combining element. The splitting element splits an input optical signal and directs it to a pair of arms (optical waveguides). The delay element makes the propagation time of one of the waveguides longer by one symbol time than the propagation time of the other of the waveguides. The phase-shift element provides the pair of waveguides with a predetermined phase difference (for example, π/4). In this regard, the phase (the amount of the phase shift) of the phase-shift element represents the phase difference generated in a pair of waveguides constituting a delay interferometer. The delay element and the phase-shift element are realized by, for example, appropriately setting the length of each waveguide. The combining element combines a pair of optical signals propagated through the pair of waveguides and outputs a pair of complementary signals. According to the configuration, the delay interferometer 1a generates an optical signal in accordance with the phase difference between the adjacent symbols.

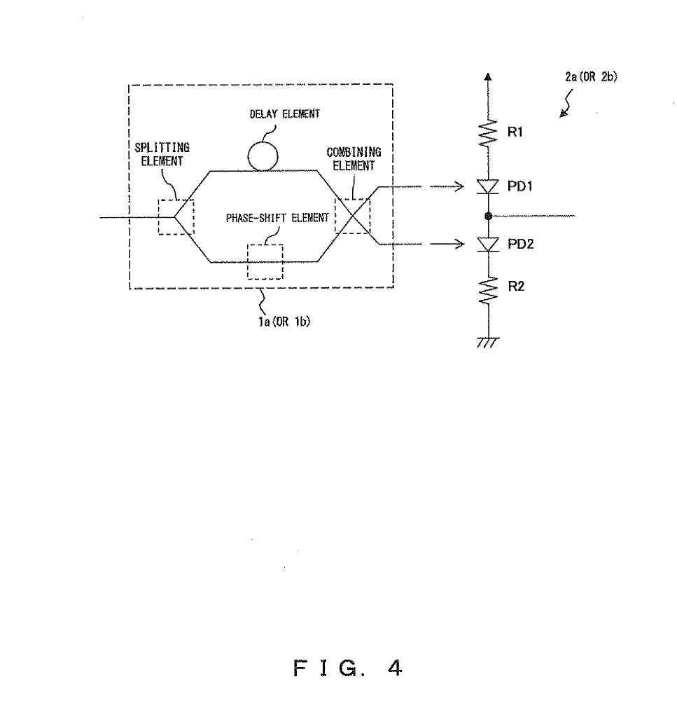

The photo detector 2a converts the optical signal output from the delay interferometer 1a into an electric signal. The photo detector 2a is realized with, for example, a pair of serially-connected photo detecting elements (such as photodiodes) PD1 and PD2, as shown in FIG. 4. In this case, one of the pair of optical signals output from the delay interferometer 1a is directed to the photo detecting element PD1, and the other is the directed to the photo detecting element PD2. Then, a current signal is output, representing the difference between currents generated by the photo detecting elements PD1 and PD2.

Shunt resistors R1 and R2 are provided as sensors for detecting the currents generated by the photo detecting elements PD1 and PD2. Therefore, the average optical power of the optical DQPSK signal input to the delay interferometer 1a can be detected by monitoring the sum of voltages across the shunt resistors R1 and R2.

In an example of FIG. 4, the resistor R2 is connected to the ground GND. However, the photo detector 2a may be configured differently. That is, the photo detector 2a may be configured in such a way that positive voltage is applied through the resistor R1 and negative voltage is applied through the resistor R2 to improve such as common mode noise tolerance.

The transimpedance amplifier 3a performs linear amplification for the current signal generated by the photodetector 2a. At this time, the current signal is converted into the voltage signal. The limiter amplifier 4a further amplifies the output signal from the transimpedance amplifier 3a. The data recovery circuit 5a recovers binary data for each symbol, from the output signal from the limiter amplifier 4a. The data recovery circuit 5a decides the data by using, for example, a threshold value. The data recovery circuit 5a may include the 3R function.

The configuration and operations of the B branch circuit are basically the same as those of the A branch circuit. However, the phase-shift element of the delay interferometer 1a and the phase-shift element of the delay interferometer 1b are different from each other. Specifically, the difference in phase between the phase-shift element of the delay interferometers 1a and 1b is adjusted to be π/2

A common adjustment unit 11 adjusts the phase of the phase-shift element of the delay interferometer 1a and the phase of the phase-shift element of the delay interferometer 1b at the same time, to the same direction, by almost the same amount of phase. Here, the phases of the delay interferometers 1a and 1b are assumed to be dependent on the temperature. The configuration is realized by, for example, forming the wave guides with a material of which refractive index (i.e. the optical path length) changes depending on the temperature.

The delay interferometers 1a and 1b are formed, for example, on the same substrate. In this case, the common adjustment unit 11 is realized with, for example, a Peltier device for adjusting the temperature of the whole substrate. In this regard, the difference between the optical lengths of a pair of waveguides in the delay interferometer 1a roughly corresponds to the length by which the light propagates within one symbol time. The configuration is the same for the delay interferometer 1b. Therefore, when the temperatures of the delay interferometers 1a and 1b change by the same amount, the phase-shift elements of the delay interferometers 1a and 1b are to be adjusted at the same time, to the same direction, by the same amount of phase. Meanwhile, the common adjustment unit 11 is not limited to the Peltier device, and may also be realized by, for example, a heater.

An individual adjustment unit 12 adjusts the phase-shift element of the delay interferometer 1b. The individual adjustment unit 12 is realized, as an example, by a heater arranged in the vicinity of the delay interferometer 1b.

A mixer 13c multiplies (or mixes) the output signal from the transimpedance amplifier 3a and the output signal from the data recovery circuit 5b. An averaging circuit 14c averages the output signal from the mixer 13c. An A/D converter 15c converts the output signal from the averaging circuit 14c into digital data. The microcontroller 16c controls the common adjustment unit 11 in accordance with the digital data output from the A/D converter 15c. In other words, a feedback control is performed for the phase-shift elements of the delay interferometers 1a and 1b, using the output signals from the transimpedance amplifier 3a and the data recovery circuit 5b.

A mixer 13d multiplies the output signal from the transimpedance amplifier 3a and the output signal from the transimpedance amplifier 3b. An averaging circuit 14d averages the output signal from the mixer 13d. An A/D converter 15d converts the output signal from the averaging circuit 14d into digital data. The microcontroller 1d controls the individual adjustment unit 12 in accordance with the digital data output from the A/D converter 15d. In other words, a feedback control is performed for the phase-shift element of the delay interferometer 1b, using the output signals from the transimpedance amplifier 3a and the transimpedance amplifier 3b.

A mixer 13e multiplies the output signal from the transimpedance amplifier 3b and the output signal from the data recovery circuit 5b. An averaging circuit 14e averages the output signal from the mixer 13e. An A/D converter 15e converts the output signal from the averaging circuit 14e into digital data. The microcontroller 16e detects an abnormal status by comparing the digital data output from the A/D converter 15e with a threshold value, and outputs an alarm representing abnormal optical input upon detection of an abnormal status.

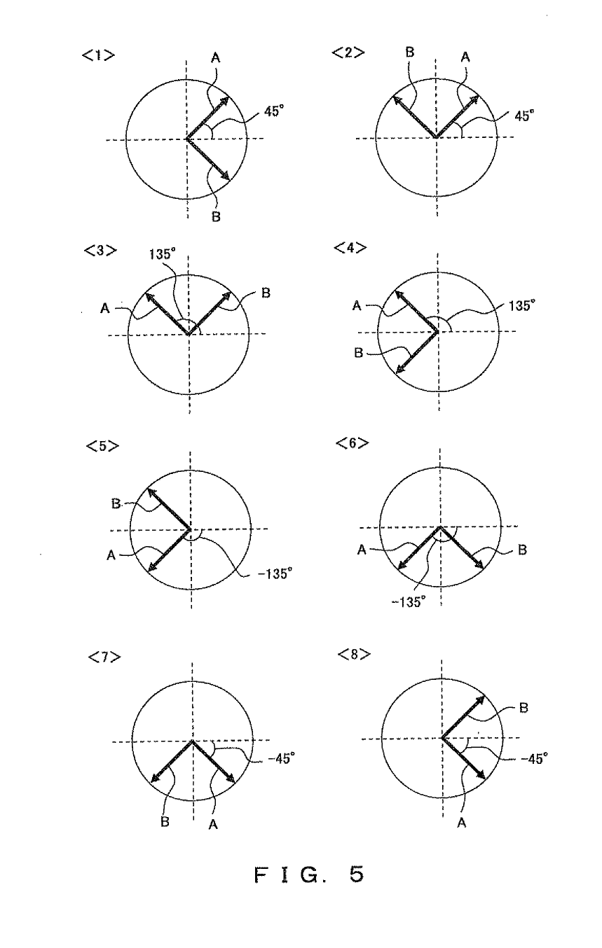

With optical DQPSK receiver having the above configuration, an optical DQPSK signal can be demodulated appropriately, when the phase-shift elements of the delay interferometers 1a and 1b are adjusted according to one of the following eight patterns. The eight patterns are shown in FIG. 5.
Pattern 1: Phase-shift element of A branch is 45 degrees, Phase-shift element of B branch is −45 degrees
Pattern 2: Phase-shift element of A branch is 45 degrees, Phase-shift element of B branch is 135 degree
Pattern 3: Phase-shift element of A branch is 135 degrees, Phase-shift element of B branch is 45 degrees
Pattern 4: Phase-shift element of A branch is 135 degrees, Phase-shift element of B branch is −135 degrees
Pattern 5: Phase-shift element of A branch is −135 degrees, Phase-shift element of B branch is 135 degrees
Pattern 6: Phase-shift element of A branch is −135 degrees, Phase-shift element of B branch is −45 degrees
Pattern 7: Phase-shift element of A branch is −45 degrees, Phase-shift element of B branch is −135 degrees
Pattern 8: Phase-shift element of A branch is −45 degrees, Phase-shift element of B branch is 45 degrees

The pair of data output from the data recovery circuit 5a and 5b may replaced with each other (channel replacement) when the combination pattern of the phase-shift element changes. In addition, the logic of each data may be inverted (bit inversion) However, the transmitted data can be recovered appropriately by providing a logic circuit in the subsequent stage of the data recovery circuits 5a and 5b to correct the channel replacement and the bit inversion in accordance with the combination pattern of the phase-shift elements. The logic circuit for controlling the logic of a bit is described in detail in, for example, Japanese Patent Application Publication No. 2006-270909.

Thus, the delay interferometer 1a provided in the A branch needs to be adjusted so that the phase of the phase-shift element (that is, the phase difference between the pair of waveguides) becomes “π/4+nπ/2” (n is an integer). Thus, the delay interferometer 1b provided in the B branch needs to be adjusted so that the phase difference between the phase of the phase-shift element of the delay interferometer 1a and the phase-shift element of the delay interferometer 1b becomes “π/2”.

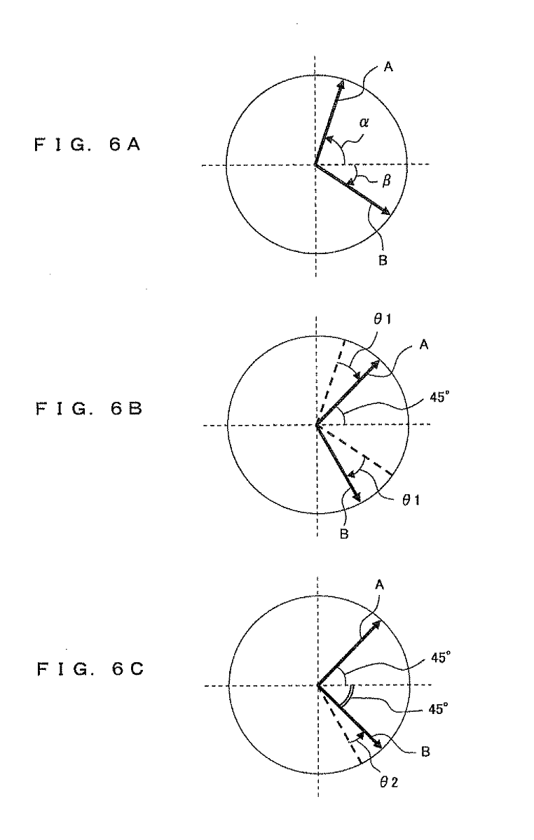

Next, the method for adjusting the phase-shift elements of the delay interferometers 1a and 1b are described. In this regard, as shown in FIG. 6A, the phase-shift elements of the delay interferometers 1a and 1b at the start of the adjustment are assumed to be “+α” and “−β”, respectively.

In the adjustment procedure according to the embodiment, the phase-shift element of the delay interferometer 1a is adjusted first to “π/4+nπ/2” (n is an integer) by performing a feedback control to the common adjustment unit 11. At this time, the common adjustment unit 11 adjusts the phase-shift elements of the delay interferometer 1a and 1b at the same time, to the same direction, by approximately the same amount of phase. Therefore, in this example, as shown in FIG. 6B, the phase-shift element of the delay interferometer 1a is adjusted to “+45 degrees” by rotating the phase elements of the delay interferometers 1a and 1b by “θ1”. Basically, the feedback control is performed so that the phase-shift element of the delay interferometer 1a becomes close to the most adjacent one of the conditions: +45 degrees, +135 degrees, −45 degrees, −135 degrees.

Next, the phase-shift element of the delay interferometer 1b is adjusted so that “the phase difference between the phase of the phase-shift element of the delay interferometer 1a and the phase of the phase-shift element of the delay interferometer 1b becomes π/2”, by performing a feedback control to the individual adjustment unit 12. At this time, the individual adjustment unit 12 adjusts only the phase-shift element of the delay interferometer 1b. In other words, the phase-shift element of the delay interferometer 1a remains unchanged. Therefore, in this example, as shown in FIG. 6C, the phase-shift element of the delay interferometer 1b is adjusted to “−45 degrees” by rotating the phase-shift element of the delay interferometer 1b by “θ2.”

The phase-shift elements of the delay interferometers 1a and 1b are adjusted to “+45 degrees” and “−45 degrees” respectively, through the above procedure, resulting in Pattern 1 shown in FIG. 5.

Thus, in the optical DQPSK signal according to the embodiment, three signals (the output signal from the transimpedance amplifier 3a, the output signal from the data recovery circuit 5b, and the output signal from the transimpedance amplifier 3b) are used to adjust the phase-shift elements of the delay interferometers 1a and 1b. In the conventional configuration shown in FIG. 2, four signals (the output signals from the photo detectors in both branches and the output signals from the data recovery circuits from of both branches) are required. Therefore, the circuit size for adjusting the phase-shift elements in the optical DQPSK receiver according to the embodiment can be reduced, compared to the conventional art.

In addition, in the conventional configuration shown in FIG. 2, the phase-shift elements of the delay interferometers are adjusted individually by the feedback control for each branch. On the other hand, in the optical DQPSK receiver according to the embodiment, the feedback control is performed utilizing the π/2 difference between the pair of the delay interferometers. In the other words, as the first step according to the embodiment, one of the phase-shift elements is set to the target value, while maintaining the difference between the phase-shift elements of both branches. As the second step, the phase-shift element of the other is adjusted, so that the phase becomes orthogonal to the phase-shift element that has been set to the target value. Then, phase-shift elements of both branches are set to the target value, by alternately performing the first step and the second step.

Meanwhile, in the configuration shown in FIG. 3, the phase-shift elements of the delay interferometers 1a and 1b are adjusted using the output signals from the transimpedance amplifier 3a and 3b. At this time, the transimpedance amplifiers 3a and 3b perform linear amplification for the output signals from the photo detectors 2a and 2b, respectively, Therefore, the output signals from the transimpedance amplifiers 3a and 3b are the essentially the same with the output signals from the photodetectors 2a and 2b, while differing in the amplitude. In other words, the phase-shift elements of the delay interferometers 1a and 1b are adjusted using the output signals from the photo detectors 2a and 2b, and the output signal from the data recovery circuit 5b.

In addition, noise removal using a filer may be performed for the output signals from the photo detectors 2a, 2b and the data recovery circuit 5b, before they are input to the mixers 13c-13e. For example, as shown in FIG. 3, lowpass filters 17-19 may be provided, with their cutoff frequency set about several hundred MHz, when the data transmission rate of the optical DQPSK signal is several dozen Gbps.

Meanwhile, the optical DQPSK receiver shown in FIG. 3 is configured so that the phase-shift element of the delay interferometer 1b is controlled with two feedback systems. If the two feedback control loops operate individually, the operation may not be stable, due to the interference between the feedback control loops determined by their response speed and the loop gain. However, there has been a know solution for the problem. The problem can be solved, for example, by increasing the response speed of the feedback loop for controlling the individual adjustment unit 12 so as to make the speed adequately faster than the response speed of the feedback loop for controlling the common adjustment unit 11.

### First Embodiment

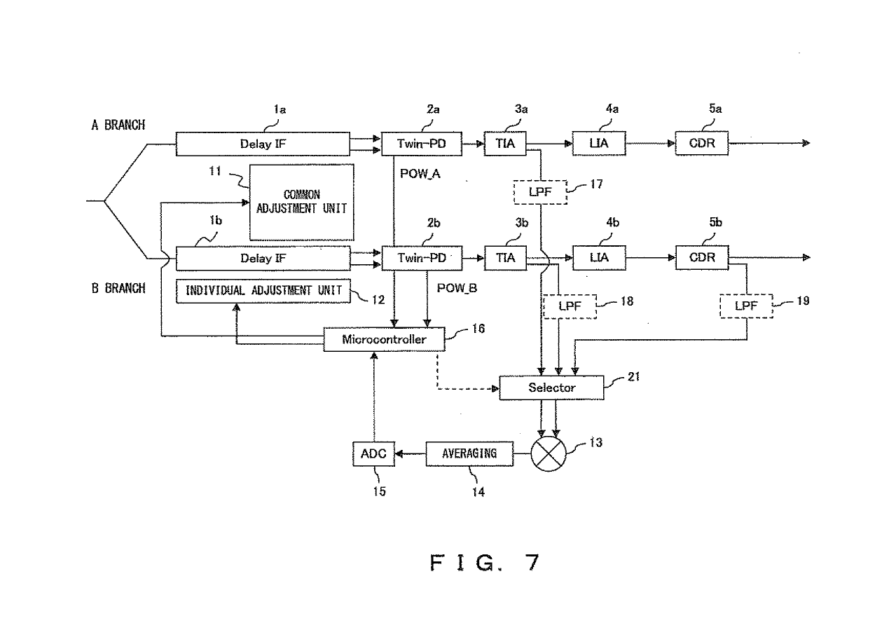

FIG. 7 shows the configuration of the optical DQPSK receiver according to the first embodiment. In FIG. 3 and FIG. 7, the same numeral indicates the same circuit element.

In FIG. 7, output signals from a transimpedance amplifier 3a, a transimpedance amplifier 3b and a data recovery circuit 5b are input to a selector 21. The selector 21 selects, from the three signals, two signals specified by a microcontroller 16.

A mixer 13 multiplies two signals selected by the selector 21. An averaging circuit 14 averages the output signal from the mixer 13. The averaging circuit 14 is realized by, for example, a lowpass filter. The cutoff frequency of the lowpass filter is set to, for example, several kHz to several hundred MHz, when the data transmission rate of the optical DQPSK signal is several dozen Gbps. An A/D converter 15 converts the output signal from the averaging circuit 14 into digital data. The microcontroller 16 controls a common adjustment unit 11 and an individual adjustment unit 12, in accordance with the digital data output from the A/D converter 15. The microcontroller 16 generates a control signal for controlling the selector 21.

The method for adjusting the phase-shift elements of the delay interferometers 1a and 1b through control of the common adjustment unit 11 and the individual adjustment unit 12 by the microcontroller 16 is as described referring to FIG. 6A-6C. Specifically, the microcontroller 16 adjusts the phase of the delay interferometer 1a to “π/4+nπ/2” (n is an integer), using the common adjustment unit 11. At this time, the same amount of change as for the delay interferometer 1a is provided to the phase-shift element of the delay interferometer 1b. Next, the microcontroller 16 adjusts the phase-shift element of the delay interferometer 1b, using the individual adjustment unit 12, so that the phase difference between the delay interferometers 1a and 1b becomes “π/2.”

Thus, according to the first embodiment, the mixers 13c-13e are realized by the mixer 13, the averaging circuits 14c-14e are realized by the averaging circuit 14, the A/D converters 15c-15e are realized by the A/D converter 15, and the microcontroller 16c-16e are realized by the microcontroller 16. Therefore, the circuit size of the optical DQPSK receiver according to the first embodiment can be reduced further.

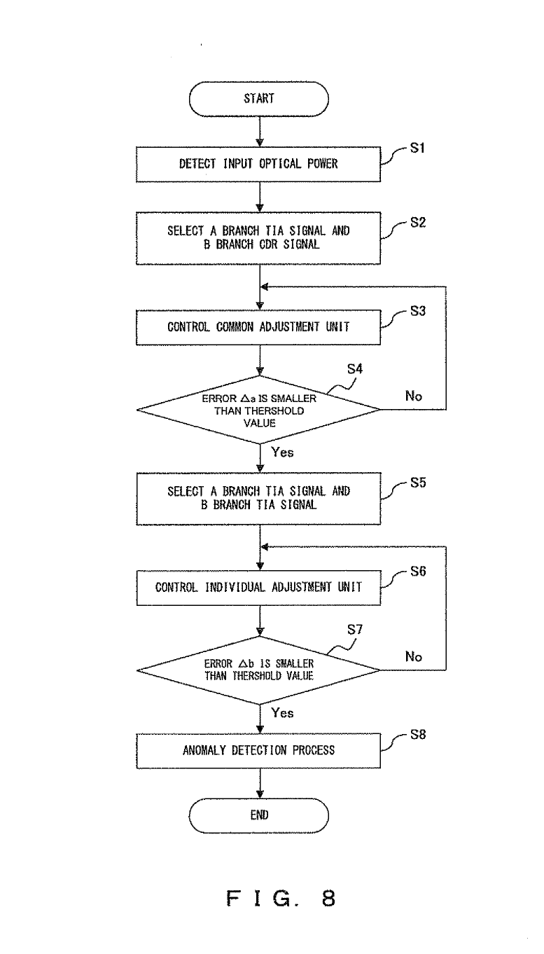

FIG. 8 shows a flowchart representing the operations of the microcontroller 16 in the first embodiment. In the following description, the output signals from the transimpedance amplifiers 3a, 3b, and the data recovery circuit 5b are referred to as “A branch TIA signal”, “B branch TIA signal”, and “B branch CDR signal”, respectively.

An A branch average input optical power (POW_A) and a B branch average input optical power (POW_B) are detected in step S1. The average input optical power of each branch is measured before it is amplified by the transimpedance amplifier. In this embodiment, the average input optical power is detected, as shown in FIG. 4, by monitoring the sum of the voltages across the shunt resistors R1 and R2 connected to the pair of photo detecting elements constituting the photo detector.

In step S2, a control signal for selecting the A branch TIA signal and the B branch CDR signal is provided to the selector 21. Accordingly, a multiplied signal of A branch TIA signal and the B branch CDR signal (hereinafter, referred to as “A_{TIA}*B_{CDR} signal”) is generated, and an signal obtained by averaging the A_{TIA}*B_{CDR} signal (hereinafter, referred to as “averaged A_{TIA}*B_{CDR} signal”) is provided to the microcontroller 16.

In steps S3 and S4, the common adjustment unit 11 is controlled in accordance with the averaged A_{TIA}*B_{CDR} signal. The control is continued until the error 5a of the delay interferometer 1a is converged within a threshold value range. The error 6a represents the difference between the phase of the phase-shift element of the delay interferometer 1a and the target value for the phase. The target value is “π/4+nπ/2” (n is an integer). The convergence within a threshold value range refers to the condition in which the error becomes sufficiently close to zero.

In the steps S3 and S4, the average A_{TIA}*B_{CDR} signal may be divided by the average input optical power POW_A. In this case, the common adjustment unit 11 is controlled in accordance with the result of the division. With the procedure, the phase-shift element of the delay interferometer 1a can be adjusted accurately, without being affected by the fluctuation of the input optical power.

In step S5, a control signal for selecting the A branch TIA signal and the B branch TIA signal is provided to the selector 21. Accordingly, a multiplied signal of A branch TIA signal and the B branch TIA signal is (hereinafter, referred to as “A_{TIA}*B_{TIA} signal”) is generated, and a signal obtained by averaging the A_{TIA}*B_{TIA} signal (hereinafter, referred to as “averaged A_{TIA}*B_{TIA} signal”) is provided to the microcontroller 16.

In steps S6 and S7, the individual adjustment unit 12 is controlled in accordance with the averaged A_{TIA}*B_{TIA} signal. The control is continued until the error δb of the delay interferometer 1b is converged within a threshold value range. The error δb represents the difference between the phase of the phase-shift element of the delay interferometer 1b and the target value for the phase. The target value is orthogonal to the phase of the phase-shift element of the A branch obtained in steps S2-S4. The convergence within a threshold value range refers to the condition in which the error becomes sufficiently close to zero.

In the steps S6 and S7, the averaged A_{TIA}*B_{TIA} signal may be divided by the average input optical power POW_A, and may be divided further by the average input optical power POW_B. In this case, the individual adjustment unit 12 is controlled in accordance with the result of the division. With the procedure, the phase-shift element of the delay interferometer 1b can be adjusted accurately, without being affected by the fluctuation of the input optical power.

In step S8, a control signal for selecting the B branch TIA signal and the B branch CDR signal is provided to the selector 21. Accordingly, a multiplied signal of B branch TIA signal and the B branch CDR signal is (hereinafter, referred to as “B_{TIA}*B_{CDR} signal”) is generated, and a signal obtained by averaging the B_{TIA}*B_{CDR} signal (hereinafter, referred to as “averaged B_{TIA}*B_{CDR} signal”) is provided to the microcontroller 16. An abnormal input or abnormal operation is detected in accordance with the averaged B_{TIA}*B_{CDR} signal. The step S8 is not a required procedure, and may be omitted.

Thus, the microcontroller 16 adjusts the phase-shift elements of the delay interferometer 1a and 1b by performing the steps S2-S7. In this regard, the A_{TIA}*B_{CDR} signal that is used for the adjustment of the phase-shift element of the A branch in the steps S3 and S4 contains a signal in the B branch. At this point, the phase-shift element of the B branch is not adjusted, and the accuracy of the A_{TIA}*B_{CDR} signal is not at a high level. For this reason, the phase-shift elements of both branches may not be adjusted accurately, only by performing the steps S2-S7 described above. Accordingly, in the optical DQPSK receiver according to the embodiment, the procedures in the steps S2-S4 and the procedures in the steps S5-S7 may be repeated alternately. Alternatively, if the phase difference between the phase-shift elements of the delay interferometers 1a and 1b can be set approximately to π/2 in advance, the phase-shift elements of the delay interferometers 1a and 1b can be adjusted immediately, without repeating the steps S1-S7.

The processes in the flowchart shown in FIG. 8 are performed, for example, at predetermined intervals. Alternatively, the temperature of the optical DQPSK signal may be monitored, and the steps S1-S8 may be performed when the temperature changes.

Next, the processes in the flowchart shown in FIG. 8 are described in detail. In the following description, it is assumed that the phase-shift element of the delay interferometer 1a in the A branch is to be adjusted to π/4 [rad], and the phase-shift element of the delay interferometer 1b in the B branch is to be adjusted to π/4 [rad].

### <Common Adjustment Procedure (Steps S3 and S4)>

In the common adjustment procedure, the phase error of the phase-shift element of the delay interferometer 1a in the A branch is detected, and the phase-shift elements of both branches are adjusted at the same time, to the same direction, in order to make the phase error zero. In this regard, the phase error represents the amount of difference with respect to the target value π/4.

Assuming that the amount of phase deviation of the phase-shift element of the delay interferometer 1a in the A branch from the target value is “δa [rad]”, a signal output from the photo detector (TWIN-PD) 2a in the A branch can be expressed with the following equation, according to the optical DQPSK reception theory.

A²(t)cos(Δφ+π/4+δa)
A(t): pulse waveform corresponding to one symbol
Δφ: phase difference between adjacent two symbols
δa: phase error of the phase-shift element of the A branch (target value=π/4)
   In the same manner, a signal output from the photodetector (TWIN-PD) 2b in the B branch can be expressed with the following equation.

A²(t)cos(Δφ−π/4+δb)
δb: phase error of the phase-shift element of the B branch (target value=−π/4)

Here, the gain components of the transimpedance amplifiers 3a and 3b are omitted for simplicity. In addition, assuming that the 3R process is to be carried out in the data recovery circuits 5a and 5b, the output signals do not contain analog values originated from the phase errors δa and δb, and can be expressed with the following equations. In this regard, the pulse of the output signals from the data recovery circuits 5a and 5b is assumed to be “1” for ease of explanation.
Output from A branch decision circuit: cos(Δφ+π/4)
Output from B branch decision circuit, cos(Δφ−π/4)

In order to control the phase error δa in the delay interferometer 1a in the A branch, the A branch TIA signal and the B branch CDR signal are selected by the selector 21, as described above. In this case, the mixer 13 multiplies these signals, to generate A_{TIA}*B_{CDR} signal. The A_{TIA}*B_{CDR} signal can be expressed with the following equation.

$${A}^{2} ( t ) cos ( Δ φ + π / 4 + δ a ) cos ( Δφ - π / 4 ) = {A}^{2} ( t ) cos ( Δφ + π / 4 + δ a ) sin ( Δφ + π / 4 ) = {A}^{2} ( t ) cos ( Δφ + π / 4 ) sin ( Δφ + π / 4 ) cos ( δ a ) - {A}^{2} ( t ) {sin}^{2} ( Δφ + π / 4 ) sin ( δ a )$$

In this regard, the phase difference Δφ is 0, π/2, π or 3π/2 in the DQPSK, and basically, the four values are equally distributed. Therefore, the first term in the above equation becomes “zero” after it is averaged by the averaging circuit 14. In addition, the second term is “−A²(t) sin (δa)/2” before the averaging operation, regardless of the phase difference Δφ. Therefore, the value obtained by averaging the second term is proportional to “−sin(δa)”.

Here, assuming that the phase error δa is small, the second term should be approximately proportional to “−δa.” In other words, the averaged A_{TIA}*B_{CDR} signal obtained by averaging the A_{TIA}*B_{CDR} signal is proportional to “−δa”, when the phase error δa is small.

The averaging circuit 14 is realized with, for example, a lowpass filter. In this case, the cutoff frequency of the lowpass filter is determined in such a way that the first term in the above equation can be regarded as zero.

Thus, the averaged A_{TIA*B}_{CDR} signal is proportional to “−δa”. In other words, the averaged A_{TIA}*B_{CDR} signal represents, not only the amount of the phase error of the delay interferometer 1a, but also the polarity (information indicating whether the shift is towards the positive direction or the negative direction) of the phase error. Therefore, the phase-shift element of the delay interferometer 1a can be adjusted to the target value accurately, by monitoring the averaged A_{TIA}*B_{CDR} signal and performing feedback control to make the signal closer to zero, using the microcontroller 16. In this case, the time required for adjustment can be reduced, since the microcontroller 16 has identified the polarity of the phase error and there is no need to determine the direction for the phase adjustment using cut-and-try method.

While it is omitted in the above equations, the amplitude of the output signal from the photo detector (TWIN-PD) is proportional to the average input optical power to the branch. For this reason, in the optical DQPSK signal according to the embodiment, the output value from the averaging circuit 14 is divided by the average input optical power, and the phase-shift element is adjusted by using the result of the division, making it possible to detect and adjust the phase error of the phase error without dependence on the optical input power.

In addition, in the common adjustment procedure, not only the signal in the A branch but also the signal in the B branch is required for the adjustment of the phase-shift element of the delay interferometer 1a. For this reason, at the start of the adjustment of the phase-shift element of the delay interferometer 1a, it is preferable that the initial phase difference between the phase-shift elements of the delay interferometer 1a and 1b is close to π/2. In other words, it is preferable that the phase error δb in the delay interferometer 1b is a value that is small to some extend (for example, equal to or smaller than ±π/36 [rad]) at the start of the common adjustment procedure. Such initial phase difference may be set at the designing stage of the delay interferometers 1a and 1b, or, the initial phase difference may be compensated by providing an offset in advance for the individual adjustment unit 12. The explanation of the methods for realizing the initial phase difference is omitted here as they are known to the persons skilled in the art. In this case, the procedures according to the embodiment play the role of fine-adjusting, with high accuracy, the phase-shift elements that have been adjusted with low accuracy.

### <Individual Adjustment Procedure (Steps S6 and 7)>

After the phase-shift element in the A branch is adjusted to π/4 in the common adjustment procedure, the phase-shift element in the B branch is adjusted in the individual adjustment procedure. In this embodiment, the target phase of the phase-shift element in the B branch is “−π/4” that proceeds by π/2 from the phase of the phase-shift element of the delay interferometer 1a in the A branch. In the above example, the initial phase difference between the delay interferometers 1a and 1b is π/2±π/36. In this case, the individual adjustment procedure corresponds to the process in which the phase error δb in the B branch converges to zero within the range of ±π/36. The optical DQPSK receiver according to the embodiments provides a function for detecting the amount of deviation, from the target value π/2, of the phase difference between the phase-shift elements of the delay interferometers 1a and 1b. Then, the phase-shift element in the B branch is adjusted while fixing the phase-shift element in the A branch, so as to make the detected value (amount of deviation) zero.

In the individual adjustment procedure, the A branch TIA signal and the B branch TIA signal are multiplied to generate A_{TIA}*B_{TIA}signal. The A_{TIA}*B_{TIA} signal can be expressed by the following equation.

A²(t)cos(Δφ+π/4+δa)*A²(t)cos(Δφ−π/4+δb)
δa: phase error of the phase-shift element in the A branch (target value: π/4)
δb: phase error of the phase-shift element in the B branch (target value: −π/4)
   However, the phase error δa in the A branch has been adjusted to zero in the common adjustment procedure described above. Therefore, assigning zero to the phase error δa, the A_{TIA}*B_{TIA} signal is expressed with the following equation.

$${A}^{2} ( t ) cos ( Δφ + π / 4 ) * {A}^{2} ( t ) cos ( Δ φ - π / 4 + δ b ) • - {A}^{4} ( t ) cos ( Δ φ - π / 4 + δ b ) sin ( Δ φ - π / 4 ) • - {A}^{4} ( t ) cos ( Δ φ - π / 4 ) sin ( Δφ - π / 4 ) cos ( δ b ) + {A}^{4} ( t ) {sin}^{2} ( Δφ - π / 4 ) sin ( δ b )$$

In this regard, the phase difference Δφ is 0, π/2, π or 3π/2 in the DQPSK, and basically, the four values are equally distributed. Therefore, the first term in the above equation becomes “zero” after it is averaged by the averaging circuit 14. In addition, the second term is “−A²(t)sin(δ)/2” before the averaging operation, regardless of the phase difference Δφ. Therefore, the value obtained by averaging the second term is proportional to “−sin(δb)”.

Here, assuming that the phase error δb is small, the second term should be approximately proportional to “−δb.” In other words, the averaged A_{TIA}*B_{TIA} signal is proportional to “−δb”, when the phase error δb is small,

Thus, the averaged A_{TIA}*B_{TIA} signal is proportional to “−δb”. In other words, the averaged A_{TIA}*B_{TIA} signal represents, not only the amount of the phase error of the delay interferometer 1b, but also the polarity of the phase error. Therefore, the phase-shift element of the delay interferometer 1b can be adjusted to the target value accurately, by monitoring the averaged A_{TIA}*B_{TIA} signal and performing feedback control to make the signal closer to zero, by the microcontroller 16. In this case, the time required for adjustment can be reduced, since the microcontroller 16 has identified the polarity of the phase error and there is no need to determine the direction for the phase adjustment using cut-and-try method.

The phase-shift element of the B branch can be adjusted by the control described above, when the phase error δa of the phase-shift element in the A branch is approximately zero. In other words, the control described above can be performed, for fine-adjusting the phase-shift element during operation. On the other hand, at the time of the initial operation of the optical DQPSK receiver, the phase error δa of the phase-shift element in the A branch is generally not zero. As described above, the A_{TIA}*B_{TIA} signal is expressed with the following equation.

A²(t)cos(Δφ+π/4+δa)*A²(t)cos(Δφ−π/4+δb) =−A⁴(t)cos(Δφ−π/4+δb)sin(Δφ−π/4+δa)

Assuming “−π/4+δa=α” in the above equation, “−π/4+δb=α+(δb−δa)” can be obtained. Accordingly, the A_{TIA}*B_{TIA} signal can be expressed with the following expression.

$$= - {A}^{4} ( t ) cos ( Δφ + α + ( δ b - δ a ) ) sin ( Δφ + α ) = - {A}^{4} ( t ) cos ( Δφ + α ) sin ( Δφ + α ) cos ( δ b - δ a ) + {A}^{4} ( t ) {sin}^{2} ( Δφ + α ) sin ( δ b - δ a )$$

In this regard, the phase difference Δφ is 0, π/2, π or 3π/2 in the DQPSK, and basically, the four values are equally distributed. Therefore, the first term in the above equation becomes “zero” after it is averaged. In addition, the second term is “−A²(t)sin(δb−δa)/2” before the averaging operation, regardless of the phase difference Δφ and α. Therefore, the value obtained by averaging the second term is proportional to “−sin(δb−δa)”.

Thus, in the optical DQPSK receiver according to the embodiment, under the condition “δb=δa”, the averaged A_{TIA}*B_{TIA} signal input to the microcontroller 16 becomes zero, in the individual adjustment procedure. In other words, when the phase error in the A branch and the phase error in the B branch are equal to each other, the phase-shift elements of both branches are orthogonal to each other, resulting in the detected value zero. Therefore, the orthogonality between both branches is detected in the individual adjustment procedure. On the other hand, when the phase error in the A branch and the phase error in the B branch are different from each other, the calculated value from the above equation is not zero. Therefore, the amount and direction of the error in the relative phase difference is detected in accordance with the calculated value.

Meanwhile, when adjusting the phase-shift element of the delay interferometer 1b towards the direction in which the relative phase difference decreases, the direction for the adjustment is determined in accordance with the initial phase difference mentioned above. For example, in the case in which the phase of the phase-shift element in the B branch has about π/2 advance relative to the phase of the phase-shift element in the A branch, if the calculated value obtained from the averaged A_{TIA}*B_{TIA} signal is larger than π/2, the relative phase difference can be reduced by delaying the phase of the phase-shift element of the B branch using the individual adjustment unit 12, thereby making the phase-shift elements of the both branches orthogonal to each other.

Meanwhile, as described above, the averaged A_{TIA}*B_{TIA} signal contains the term “A⁴(t)”, which is generated by the multiplication with “A²(t)” representing the amplitude in the photo detectors (TWIN-PDs) in the A branch and B branch. The term “A²(t)” affects the detected gain since it is amplified respectively in the A branch and the B branch. Therefore, in the optical DQPSK receiver according to the embodiment, in the same manner as in the common adjustment procedure, the calculated value obtained from the averaged A_{TIA}*B_{TIA} signal is divided by the value of the average optical input power in the A branch, and further divided by the value of the average optical input power in the B branch, thereby making it possible to detect and adjust the phase error without dependence on the optical input power.

While the above example shows the case in which the phases of the phase-shift elements in the delay interferometers 1a and 1b are +π/4 and −π/4, the error is detected according to the same method for the other seven patterns, and feedback control is performed to make the error zero. As a result, the phase-shift elements of both branches are adjusted to the respective target phases.

### <Anomaly Detection Procedure (Step S8)>

The anomaly detection (or failure detection) procedure is performed after the common adjustment procedure and the individual adjustment procedure described above are carried out once or more. At this time, the optical DQPSK receiver according to the embodiment performs feedback control so that the phase error of the phase-shift elements of the delay interferometers 1a and 1b is adjusted to a value within a target range (for example, within ±π/180). In other words, when the input signal to the optical DQPSK signal is normal and the optical DQPSK receiver is operating normally, the phase error of each phase-shift element is to be converged to a sufficiently small level.

In this embodiment, the anomaly detection procedure utilizes the B branch TIA signal and the B branch CDR signal. Therefore, the selector 21 selects these two signals in accordance with the microcontroller 16. Then, the mixer 13 generates a B_{TIA}*B_{CDR} signal, and the averaging circuit 14 generates an averaged B_{TIA}*B_{CDR} signal. The microcontroller 16 divides the averaged B_{TIA}*B_{CDR} signal by the value of the average input optical power in the B branch, and compares the result of the division (hereinafter, referred to as an anomaly detection value) with a judgment threshold value. If the anomaly detection value is smaller than the judgment threshold value, the microcontroller 16 determines that there is an abnormal status, and outputs and alarm signal.

The conditions in which the anomaly detection value becomes smaller than the threshold value may include, for example, the following five cases.
1) The optical input does not contain a phase modulated optical signal (signal light S), or the ratio of the signal light S to the ASE light is very small. When the optical input does not contain the phase modulated optical signal, only the ASE light is input to the optical DQPSK receiver.
2) The distortion of the signal is so large that the optical signal cannot be decided.
3) The data recovery circuits 5a or 5b is in failure status. For example, the decided phase of the data and/or clock has a large error due to the anomaly in the data recovery circuit, and the error ratio of the data decision exceeds the acceptable level.
4) The output from the transimpedance amplifiers 3a and 3b is abnormal.
5) Other circuit failure.

The optical DQPSK receiver shown in FIG. 7 is configured to detect an abnormal status using the B branch TIA signal and the B branch CDR signal, checking for a hardware failure in the B branch. Accordingly, a hardware failure in the A branch is not to be detected directly. However, since a received optical DQPSK signal is split and directed to both A branch and B branch, an abnormal input optical signal can be detected with this configuration.

As described above, the optical DQPSK receiver according to the first embodiment is capable of monitoring an abnormal status, as well as adjusting the phase-shift elements of the delay interferometers 1a and 1b using the three signals (A branch TIA signal, B branch TIA signal and B branch CDR signal). In addition, since the selector 21 is provided in the configuration to select corresponding two signals, the mixer 13, averaging circuit 14, A/D converter 15 and microcontroller 16 are shared for the common adjustment procedure, individual adjustment procedure and the anomaly detecting procedure. Therefore, the circuit size of the optical DQPSK receiver according to the embodiment is smaller than the circuit size in the conventional art (particularly, the configuration described in Patent Document 2).

### Second Embodiment

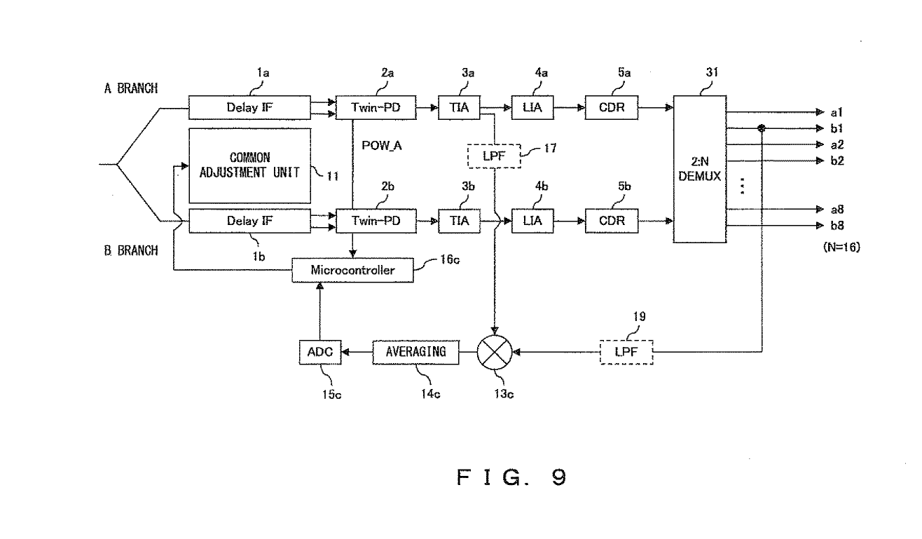

FIG. 9 shows the configuration of the optical DQPSK receiver according to the second embodiment. Only the circuit for performing the common adjustment procedure is illustrated, and the circuits for performing the individual adjustment procedure and the anomaly detection procedure are omitted from the drawing. Note that the optical DQPSK receiver according to the second embodiment may be configured, in the same manner as the configuration shown in FIG. 7, so that the mixer, averaging circuit, A/D converter and microcontroller are shared.

The basic configuration of the optical DQPSK receiver according to the second embodiment is the same as that for the optical DQPSK receiver shown in FIG. 3, with the addition of a DEMUX circuit 31. The DEMUX circuit 31 is a 2:N demultiplex circuit, which demultiplexes the data recovered by the data recovery circuits 5a and 5b in the time-division method.

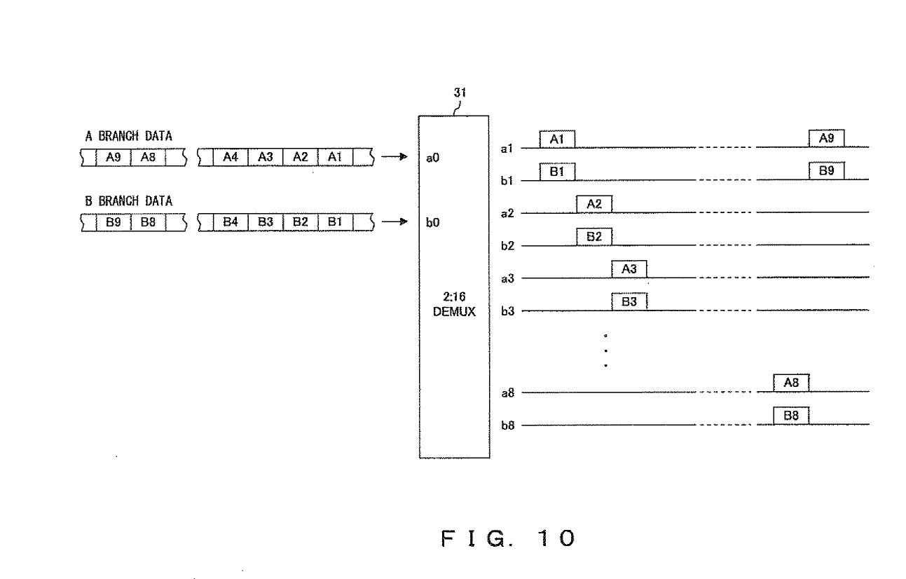

FIG. 10 shows the operations of the DEMUX circuit 31. FIG. 10 is based on an assumption “N=1”, and the DEMUX circuit 31 has two input ports a0 and b0, and sixteen output ports a1-a8 and b1-b8. The data sequence recovered by the data recovery circuit 5a is input to the input port a0. Then, each bit in the data sequence is sequentially output from the output ports a1-a8. The same process is applied for the data sequence recovered by the data recovery circuit 5b.

The mixer 13c multiplies an A branch TIA signal and a b1 signal. The A branch TIA signal is a signal that has been detected by the photo detector 2a and amplified by the transimpedance amplifier 3a. The b1 signal is one of the signals obtained by demultiplexing the B branch CDR signal in the DEMUX circuit 31 and output from the output port b1 of the DEMUX circuit 31. A signal output from any of the output ports b2-b8 may also be used, instead of the b1 signal.

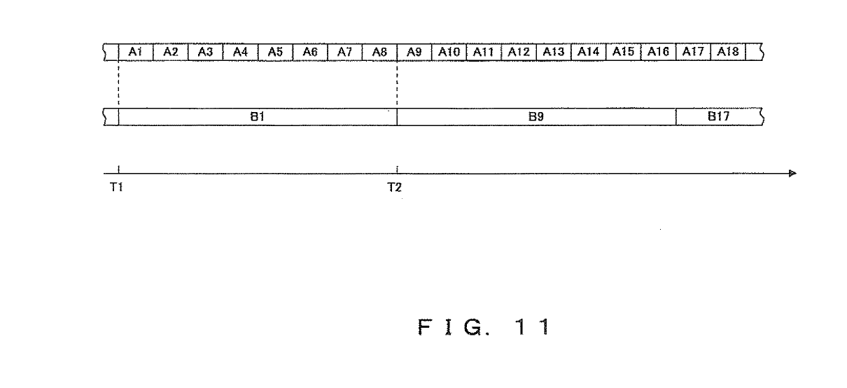

FIG. 11 shows the operations of the mixer 13c in the second embodiment. The A branch TIA signal and the b1 signal are input to the mixer 13c. The A branch TIA signals A1, A2, A3 . . . are analog signals before decision by the data recovery circuit 5a. The mixer 13c sequentially multiplies A branch TIA signals A1-A8 and the b1 signal B1 during the time periods T1-T2. By y his operation, multiplied signals A1*B1□A2*BA□A3*B1□A4*B1□A5*B1□A6*B1□A7*B1□A8*B1 are sequentially obtained.

“A1” and “B1” are signals obtained from the same symbol and correlate with each other. Therefore, the multiplied signal A1*B1 corresponds to the A_{TIA}*B_{CDR} signal described in the first embodiment. On the other hand, “A2-A8” and “B1” do not correlate with each other. Therefore, A2*B1-A8□*B1 become zero when they are averaged.

The averaging circuit 14c averages the output signal from the mixer 13c. As a result of the averaging operation, the averaged A_{TIA}*B_{CDR} signal described in the first embodiment is obtained for the A branch TIA signal A1, and the A branch TIA signals A2-A8 become zero. Therefore, the microcontroller 16c is capable of adjusting the phase-shift element of the delay interferometer 1a to the target value by controlling the common adjustment unit 11 in the same manner as in the first embodiment, using the output signal from the averaging circuit 14c. However, in this configuration, the detection sensitivity is ⅛ of the detection sensitivity in the first embodiment.

In the optical DQPSK receiver according to the second embodiment, the individual adjustment procedure is realized, in the same manner as in the first embodiment, using the A branch TIA signal and the B branch TIA signal. In addition, the anomaly detection procedure is realized using the B branch TIA signal and the b1 signal.

The configuration shown in FIG. 9 is based on an assumption that the values of the respective bits in an input signal are random. In other words, an input signal having a predetermined bit pattern may result in a large detection error. For example, in FIG. 11, when a fixed value (for example, “1”) is to be set at an interval of 8 bits (A1, A9, A17 . . . ), the output signal from the averaging circuit 14c becomes dependent on the fixed value. Specifically, in the following equation representing the A_{TIA}*B_{CDR} signal, the first term does not become zero, as Δφ is not distributed equally.

A²(t)cos(Δφ+π/4)sin(Δφ+π/4)cos(δa)−A²(t)sin²(Δφ+π/4)sin(δa)

This results in the deterioration in the detection accuracy for the phase error, leading to the deterioration in the adjustment accuracy for the phase-shift element.

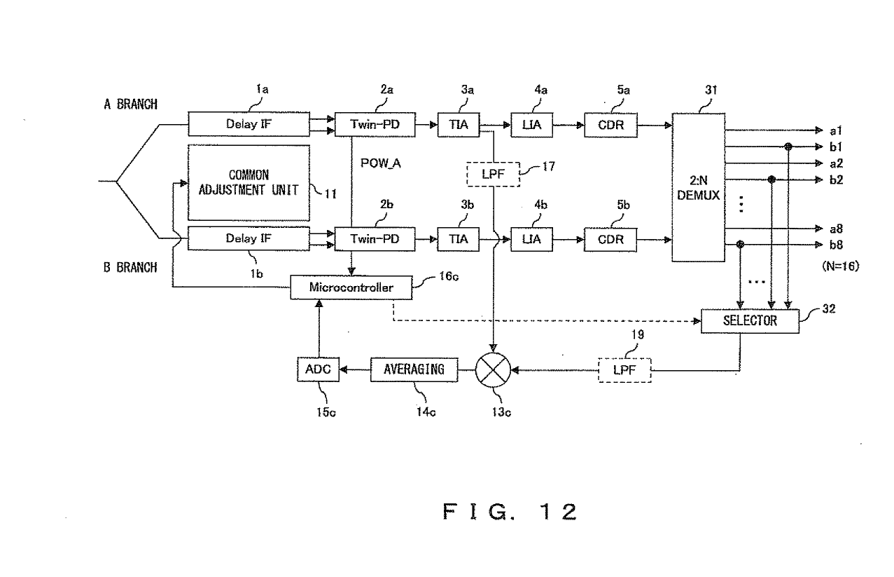

FIG. 12 shows the configuration of the optical DQPSK receiver having a function for solving the above problem. In FIG. 12, the selector 32 sequentially selects the output ports b1-b8 of the DEMUX circuit 31, in accordance with the instruction from the microcontroller 16c.

When the output port b1 is selected, the operation is the same as the configuration shown in FIG. 9, and a signal A1*B1 is obtained by the averaging operation. Next, when the output port b2 is selected, a signal A2*B2 is obtained. In the same manner, when the output ports b3-b8 are selected, signals A3*B3-A8*B8 are obtained, respectively. Thus, the signals A1*B1-A8*B8 can be obtained, by sequentially selecting the output ports b1-b8 of the DEMUX circuit 31. In this embodiment, the phase-shift element is adjusted by utilizing the sum of the signals A1*B1-A8*B8. Specifically, the phase-shift element is adjusted in accordance with “the sum of the detected values in the respective output ports/the average input optical power in the A branch during the calculation period in respective output ports”. According to this configuration, even when the values of the respective bits in an input signal are not random, the influence of the detection error mentioned above can be suppressed.

Meanwhile, assuming that the input signal has approximately random values and that the distribution of the detected values using only one DEMUX output port approximates the normal distribution, the error in the final detected value when using four ports, for example, is expected to be reduced to 1/√4=½ of the error in the condition using one port.

When the eight patterns shown in FIG. 5 are allowed as the combination of the phase-shift elements of the pair of the delay interferometers in an optical DQPSK signal, a decision logic process is required. The configuration and operations of the decision logic circuit are described in Japanese Patent Application Publication No. 2006-270909.

A pair of signals obtained by the demodulation may be replaced with each other or their bit logic may be inverted. Here, the condition in which the phase of the phase-shift elements of the delay interferometers 1a and 1b are “+π/4” and “−π/4” is defined as the reference status, and the demodulated signals in the A branch and B branch in the status are called “I” and “Q”, respectively. Then, it is assumed, for example, that the phases of the phase-shift elements in both branches are respectively shifted by π/2 with respect to the referent status. In other words, the phase-shift elements in the delay interferometers 1a and 1b are to be adjusted to “+π/4” and “+π/4”, respectively. In this case, the demodulated signal in the A branch is “inverted Q” and the demodulated signal in the B branch is “I”.

In the configuration shown in FIG. 9 or FIG. 12, assuming that synchronization error does not occur and the timing of the input/output is maintained within the DEMUX circuit 31, the adjacent bits in the DEMUX output are to be replaced with each other. In other words, after the phase pattern of the phase-shift elements of the delay interferometers 1a and 1b are determined, the transmitted data can be recovered without bit replacement process, provided that the output port is defined appropriately in accordance with the phase pattern.

In the configuration shown in FIG. 9 or FIG. 12, during the feedback control for the A branch, a feedback system runaway may occur due to a temporary synchronization error and the like within the DEMUX circuit 31. However, when the demultiplexed signals of the B branch CDR signal are output from the output ports b1-b8, the multiplied signal obtained in the mixer 13c returns to the normal value, and the feedback control for the delay interferometer in the A branch recovers automatically.

In addition, when the detection circuit including the mixer 13c is realized with a general-purpose chip and the bandwidth is limited to about 1/20-1/200 of the bit rate of a signal, a value can be detected for the signal also in the configuration using a Bessel lowpass filter as the lowpass filter, since the signal contains a component having correlation. When the input signal has random bits and the integration time in the averaging circuit is sufficiently long, the detected amount is dependent on the ratio of the efficient voltages of the output signal spectrum from the data recovery circuit 5b and the signal spectrum included in the bandwidth of the lowpass filter, and a correlation of the bits determined in the DEMUX circuit 31.

Meanwhile, the optical DQPSK receiver in the embodiments may be configured to include the functions described in Patent Document 2 (for example, the function for removing the DC offset, the function for averaging the mixer output, and so on).

What is claimed is:

1. An optical DQPSK receiver comprising:
a first branch circuit comprising a first delay interferometer having a first phase-shift element, a first photo detector for detecting output light from the first delay interferometer, and a first recovery circuit for recovering data from an output signal from the first photo detector;
a second branch circuit comprising a second delay interferometer having a second phase-shift element, a second photo detector for detecting output light from the second delay interferometer, and a second recovery circuit for recovering data from an output signal from the second photo detector;
a common adjustment unit for adjusting the first phase-shift element and the second phase-shift element;
an individual adjustment unit for adjusting the second phase-shift element; and
a control unit for controlling the common adjustment unit in accordance with a first signal output from the first photo detector and a second signal output from the second recovery circuit, and for controlling the individual control unit in accordance with the first signal and a third signal output from the second photo detector.

2. The optical DQPSK receiver according to claim 1, wherein
the common adjustment unit adjusts a phase of the first phase-shift element and a phase of the second phase-shift element, while keeping the difference between the phases of the first and second phase-shift elements, in accordance with a control performed by the control unit.

3. The optical DQPSK receiver according to claim 1, wherein
the common adjustment unit adjusts a phase of the first phase-shift element and a phase of the second phase-shift element at a same time, to a same direction, and by approximately a same amount, in accordance with a control performed by the control unit.

4. The optical DQPSK receiver according to claim 1, wherein
each of the first and second phase-shift elements is optical medium of which optical path length changes in accordance with temperature, and
the common adjustment unit adjusts temperature of the first phase-shift element and the second phase-shift element at the same time, in accordance with a control performed by the control unit.

5. The optical DQPSK receiver according to claim 4, wherein
the individual adjustment unit is a heater for adjusting the temperature of the second phase-shift element, in accordance with the control performed by the control unit.

6. The optical DQPSK receiver according to claim 1, wherein
the control unit controls the common adjustment unit so that a phase of the first phase-shift element becomes π/4+nπ/2 (n is an integer).

7. The optical DQPSK receiver according to claim 6, wherein
the control unit controls the individual adjustment unit so that a difference between the phase of the first phase-shift element and a phase of the second phase-shift element becomes π/2.

8. The optical DQPSK receiver according to claim 1, further comprising:
a selector for selecting the first and second signals from the first through third signals when a first operation mode is specified by the control unit, and for selecting the first and third signals from the first through third signals when a second operation mode is specified by the control unit;
a mixer for multiplying the two signals selected by the selector; and
an averaging circuit for averaging an output signal from the mixer, wherein
the control unit controls, in the first operation mode, the common adjustment unit in accordance with an output signal from the averaging circuit, and controls, in the second operation mode, the individual adjustment unit in accordance with the output signal from the averaging circuit.

9. The optical DQPSK receiver according to claim 8, wherein
the control unit alternately repeats the first and second operation modes.

10. The optical DQPSK receiver according to claim 8, further comprising:
a monitor circuit for monitoring an average optical input power in the first and second delay interferometers; and
a division circuit for dividing the output signal from the averaging circuit by the average optical input power in the first delay interferometer when the first signal is selected by the selector, and for dividing the output signal from the averaging circuit by the average optical input power in the second delay interferometer when the third signal is selected by the selector.

11. The optical DQPSK receiver according to claim 8, wherein
the selector selects the second and third signals when a third operation mode is specified by the control unit, and
the control unit detects, in the third operation mode, an abnormal status by comparing an output signal from the averaging circuit with a predetermined threshold value.

12. An optical DQPSK receiver comprising;
a first branch circuit comprising a first delay interferometer having a first phase-shift element, a first photo detector for detecting output light from the first delay interferometer, and a first recovery circuit for recovering data from an output signal from the first photo detector;
a second branch circuit comprising a second delay interferometer having a second phase-shift element, a second photo detector for detecting output light from the second delay interferometer, and a second recovery circuit for recovering data from an output signal from the second photo detector;
a demultiplex circuit for demultiplexing data recovered by the first and second recovery circuits;
a common adjustment unit for adjusting the first phase-shift element and the second phase-shift element;
an individual adjustment unit for adjusting the second phase-shift element; and
a control unit for controlling the common adjustment unit in accordance with a first signal output from the first photo detector and a second signal obtained by demultiplexing, in the demultiplex circuit, an output signal from the second recovery circuit, and for controlling the individual control unit in accordance with the first signal and a third signal output from the second photo detector.

13. The optical DQPSK receiver according to claim 12, further comprising:
a select or for sequentially selecting a plurality of second signals obtained by demultiplexing, in the demultiplex circuit, an output signal from the second recovery circuit; and
a mixer for multiplying the first signal with the respective second signals sequentially selected by the selector, wherein
the control unit controls the common adjustment unit in accordance with a plurality of results of the multiplication obtained by the mixer.

14. A phase monitor apparatus used in an optical DQPSK receiver comprising a first branch circuit comprising a first delay interferometer having a first phase-shift element, a first photo detector for detecting output light from the first delay interferometer, and a first recovery circuit for recovering data from an output signal from the first photo detector; and a second branch circuit comprising a second delay interferometer having a second phase-shift element, a second photodetector for detecting output light from the second delay interferometer, and a second recovery circuit for recovering data from an output signal from the second photo detector, comprising:
a monitor unit for monitoring a phase error of the first phase-shift element in accordance with a first signal output from the first photo detector and a second signal output from the second recovery circuit, and for monitoring a phase error of the second phase-shift element in accordance with the first signal and a third signal output from the second photo detector.
